(19) United States
(12) Patent Application Publication
(10) Pub. No.: US 2022/0363857 A1
(43) Pub. Date: Nov. 17, 2022

(54) FOAMED CELLULOSE ESTERS

(71) Applicant: Eastman Chemical Company, Kingsport, TN (US)

(72) Inventors: Michael Eugene Donelson, Kingsport, TN (US); David Wayne Compton, Weber City, VA (US); Marcus David Shelby, Fall Branch, TN (US); Carlo Anthony Testa, Bollington (GB)

(73) Assignee: Eastman Chemical Company, Kingsport, TN (US)

(21) Appl. No.: 17/753,825

(22) PCT Filed: Sep. 24, 2020
(86) PCT No.: PCT/US2020/052395

§ 371 Date: Mar. 16, 2022

Related U.S. Application Data
(60) Provisional application No. 62/905,582, filed on Sep. 25, 2019.

(51) Int. Cl. C08J 9/14; C08J 9/228

(52) U.S. Cl. CPC C08J 9/141; C08J 9/228; C08J 2203/14; C08J 2301/14

(57) ABSTRACT

Cellulose ester compositions for expanded foam applications are provided. Specifically, production of melt processed cellulose esters has historically been limited to standard extrusion, molding and solvent casting methods. A combination of cellulose ester formulation and selected blowing agents have been found to produce articles of good density and good dimensional stability for an expanded foam process using conventional polystyrene processing equipment.

### FIELD OF THE INVENTION

This invention belongs to the field of polymer science. In particular, it relates to certain cellulose ester polymers and their use in foamed articles.

### BACKGROUND OF THE INVENTION

In general, thermoplastic materials of various types may be expanded from an infused granular pellet or bead to form a porous, cellular, solidified foam-like structures by the action of various propellants or solvents for expanding or “blowing” the materials. The blowing agents in this context are typically gases or gas-generating substances or highly fugacious liquids which have been dissolved or intimately incorporated within the thermoplastic materials. The application of heat, with optional reduction in pressure, causes the blowing agent to be released or thermally expanded, or both, while the thermoplastic material is attaining a foaming temperature at which it is sufficiently softened and yieldable to permit the pressure of the thermally expanding blowing agent to expand it into the desired foam structure. (See, for example, U.S. Pat. No. 2,958,905, incorporated herein by reference.)

### SUMMARY OF THE INVENTION

It is desirable to manufacture high quality foam articles comprising cellulose esters. We have discovered that in the manufacturing of foam comprising cellulose esters that the blowing agent selection and management impacts the density and dimensional stability of the of the foamed article thus formed. The expanded process for foam requires blowing agent management from the production of the beads or pellets, to the expansion of the beads or pellets, and to the molding of the foam boards or foam parts. Balancing density and foam board shrinkage has been difficult to achieve in past work with cellulose esters. We have discovered that the use of branched blowing agents, particularly five and six carbon branched alkane blowing agents such as isopentane, isohexane, and 2,3-dimethyl butane are beneficial to producing parts with low density and good dimensional stability. We have also discovered that further density reduction can be achieved by subjecting the pellets used to make the foam boards or foam parts to pre-expansion conditions two times instead of once.

### DETAILED DESCRIPTION OF THE INVENTION

In a first aspect, the application discloses a process for preparing a cellulose ester foam, which comprises

(I) compounding a cellulose ester composition comprising:
(A) a cellulose ester having
(i) a DS of acetyl of about 0.0 to about 1.0;
(ii) a DS of butyryl of about 1.6 to about 3.0;
(iii) a DS of hydroxyl of about 0.0 to about 0.40; and
(iv) a Mn of about 2000 to about 95,000; and optionally
(B) a filler;
   and forming pellets; followed by
   (II) infusing said pellets with at a blowing agent chosen from branched five carbon and six carbon alkanes to form infused pellets; followed by
   (III) thermally expanding said infused pellets to form a foam.

In one embodiment, or in the alternative in combination with any other embodiment, the DS of acetyl will range from about 0.1 to about 0.6. In one embodiment, or in the alternative in combination with any other embodiment, the DS of acetyl will range from about 0.2 to about 0.5. In one embodiment, or in the alternative in combination with any other embodiment, the DS of acetyl will range from about 0.2 to about 0.6. In one embodiment, or in the alternative in combination with any other embodiment, the DS of acetyl will range from about 0.3 to about 0.6. In one embodiment, or in the alternative in combination with any other embodiment, the DS of acetyl will range from about 0.4 to about 0.6. In one embodiment, or in the alternative in combination with any other embodiment, the DS of acetyl will range from about 0.1 to about 0.5. In one embodiment, or in the alternative in combination with any other embodiment, the DS of acetyl will range from about 0.1 to about 0.4. In one embodiment, or in the alternative in combination with any other embodiment, the DS of acetyl will range from about 0.1 to about 0.3.

In one embodiment, or in the alternative in combination with any other embodiment, the DS of butyryl will range from about 2.2 to about 2.95. In one embodiment, or in the alternative in combination with any other embodiment, the DS of butyryl will range from about 2.2 to about 2.90. In one embodiment, or in the alternative in combination with any other embodiment, the DS of butyryl will range from about 2.2 to about 2.8. In one embodiment, or in the alternative in combination with any other embodiment, the DS of butyryl will range from about 2.2 to about 2.7. In one embodiment, or in the alternative in combination with any other embodiment, the DS of butyryl will range from about 2.2 to about 2.6. In one embodiment, or in the alternative in combination with any other embodiment, the DS of butyryl will range from about 2.2 to about 2.5.

In one embodiment, or in the alternative in combination with any other embodiment, the DS of hydroxyl will range from about 0.01 to about 0.3. In one embodiment, or in the alternative in combination with any other embodiment, the DS of hydroxyl will range from about 0.01 to about 0.2. In one embodiment, or in the alternative in combination with any other embodiment, the DS of hydroxyl will range from about 0.01 to about 0.1.

In one embodiment, or in the alternative in combination with any other embodiment, the Mn will range from about 15,000 to 70,000. In one embodiment, or in the alternative in combination with any other embodiment, the Mn will range from about 20,000 to 70,000. In one embodiment, or in the alternative in combination with any other embodiment, the Mn will range from about 30,000 to 70,000. In one embodiment, or in the alternative in combination with any other embodiment, the Mn will range from about 40,000 to 70,000. In one embodiment, or in the alternative in combination with any other embodiment, the Mn will range from about 50,000 to 70,000.

In one embodiment, or in the alternative in combination with any other embodiment, the Mn will range from about 15,000 to 50,000.

In one embodiment, or in the alternative in combination with any other embodiment, the DS of acetyl will range from about 0.1 to about 0.6; the DS of butyryl will range from about 2.2 to about 2.95; the DS of hydroxyl will range from about 0.01 to about 0.3; and the Mn will range from about 15,000 to 70,000.

In one embodiment, or in the alternative in combination with any other embodiment, the thermally expanding step can be achieved by (i) pre-expanding the infused pellets by treatment of the infused pellets with steam to form a first foam pellets, and (ii) molding the first foam pellets in a foam. In one class of this embodiment, the foam is a shaped article.

In one embodiment, or in the alternative in combination with any other embodiment, the thermally expanding step can be achieved by (i) pre-expanding the infused pellets by treatment of the infused pellets with steam to form a first foam pellets, (ii) further pre-expanding the first foam pellets with steam to form a second foam pellets, and (iii) molding the second foam pellets into a foam. In one class of this embodiment, the foam is a shaped article.

In one embodiment, or in the alternative in combination with any other embodiment, the first foam pellets prepared during the first pre-expansion substep can have a density of less than 50 g/L, or less than 45 g/L, or less than 40 g/L, or less than 35 g/L, or less than 30 g/L, or less than 25 g/L, or less than 23 g/L, or less than 20 g/L. In one embodiment, or in the alternative in combination with any other embodiment, the second foam pellets prepared during the second pre-expansion substep can be less than less than 30 g/L, or less than 25 g/L, or less than 23 g/L, or less than 20 g/L, or less than 15 g/L. In one embodiment, or in the alternative in combination with any other embodiment, the foam can have a density of less than 50 g/L, or less than 45 g/L, or less than 40 g/L, or less than 35 g/L, or less than 30 g/L, or less than 25 g/L, or less than 23 g/L, or less than 20 g/L.

In an alternate process, the cellulose ester optionally compounded with a filler, can be added to an extruder, for example a single screw extruder and the blowing agent can be infused into the molten compounded cellulose ester and then blown into a formed article. In such processes, the form of the (blowing agent) infused composition at the conclusion of step (I) can be a pellet, a board, a film, or a sheet (formed, for example, directly in an Extruded Polystyrene (XPS)-type process.

In another aspect, the application discloses a process for preparing a cellulose ester foam, which comprises

(I) compounding a cellulose ester composition comprising:
(A) a cellulose ester having
(i) a DS of acetyl of about 0.0 to about 1.0;
(ii) a DS of butyryl of about 1.6 to about 3.0;
(iii) a DS of hydroxyl of about 0.0 to about 0.40; and
(iv) a Mn of about 2000 to about 95,000; and optionally
(B) a filler;
   and forming pellets; followed by
   (II) infusing said pellets with at a blowing agent chosen from branched five carbon and six carbon alkanes to form infused pellets; followed by
   (III) thermally expanding said infused pellets to form foam pellets.

In one embodiment, or in the alternative in combination with any other embodiment, the thermally expanding step can be achieved by (i) treating the infused pellets with steam to form a first foam pellets.

In one embodiment, or in the alternative in combination with any other embodiment, the thermally expanding step can be achieved by (i) treating the infused pellets with steam to form a first foam pellets, (ii) further treating the first foam pellets with steam to form a second foam pellets.

In one embodiment, or in the alternative in combination with any other embodiment, the first foam pellets can have a density of less than 50 g/L, or less than 45 g/L, or less than 40 g/L, or less than 35 g/L, or less than 30 g/L, or less than 25 g/L, or less than 23 g/L, or less than 20 g/L. In one embodiment, or in the alternative in combination with any other embodiment, the second foam pellets can be less than less than 30 g/L, or less than 25 g/L, or less than 23 g/L, or less than 20 g/L, or less than 15 g/L.

Accordingly, in a second aspect, the application discloses a process for preparing a cellulose ester foam, which comprises:

(I) infusing a cellulose ester composition with a blowing agent chosen from branched five carbon and six carbon alkanes, wherein said cellulose ester composition comprises:
(A) a cellulose ester having
(i) a DS of acetyl of about 0.01 to about 1.0;
(ii) a DS of butyryl of about 1.6 to about 3.0;
(iii) a DS of hydroxyl of about 0.0 to about 0.40; and
(iv) a Mn of about 2000 to about 95,000; and optionally
(B) a filler; followed by
   (II) thermally expanding said composition to form a foam.

In one embodiment, or in the alternative in combination with any other embodiment, the cellulose ester compositions comprise at least one filler, such as graphite, silicon dioxide, carbon black, talc, calcium carbonate, clay, calcium sulfate, boron nitride, aluminum trihydrate, magnesium hydroxide, wood flour, and natural and synthetic waxes.

The filler so utilized is not limiting in any way and can be chosen to suit the intended end-use of the cellulose ester foam and it's desired appearance and physical performance characteristics. Certain inorganic fillers, such as talc and graphite, can also serve as nucleating agents in the formation of the blown foams. If the chosen filler cannot also serve as a nucleating agent, then additional nucleating agent should be added to the composition to ensure proper formation of the cellulose ester foams. Such nucleating agents include natural waxes and synthetic waxes (such as polyolefin waxes and polyamide waxes).

In the compounding step above, one embodiment, or in the alternative in combination with any other embodiment, the process involves the melt blending of the various components.

In one embodiment, or in the alternative in combination with any other embodiment, the cellulose ester compositions further comprise at least one additive selected from the group comprising antioxidants, thermal stabilizers, mold release agents, antistatic agents, whitening agents, colorants, flow aids, processing aids, plasticizers, anti-fog additives, minerals, UV stabilizers, lubricants, chain extenders, nucleating agents, reinforcing fillers, wood or flour fillers, glass fiber, carbon fiber, flame retardants, dyes, pigments, colorants, additional resins and combinations thereof.

In one embodiment, or in the alternative in combination with any other embodiment, the cellulose ester composition includes stabilizers chosen from antioxidants, acid scavengers, or a combination thereof. In one embodiment, or in the alternative in combination with any other embodiment, the cellulose ester composition includes an antioxidant in the range from about 0.1 to about 0.8 wt % based on the total weight of the composition. In one embodiment, or in the alternative in combination with any other embodiment, the antioxidant is 3,9-bis(2,4-di-tert-butylphenoxy)-2,4,8,1 0-tetraoxa 3,9-diphosphaspiro[5.5]undecane. In one embodiment, or in the alternative in combination with any other embodiment, the cellulose ester composition includes an acid scavenger in the range from about 0.2 to about 6.0 weight percent, or 0.5 to 4 weight percent, based on the total weight of the composition. In one embodiment, or in the alternative in combination with any other embodiment, the acid scavenger is an epoxidized fatty acid ester. Examples of suitable acid scavengers include epoxidized octyl tallate, epoxidized soybean oil, and epoxidized linseed oil, and the like. Additionally, antioxidants which can be used include Irganox® 1010 (Pentaerythritol tetrakis(3-(3,5-di-tert-butyl-4-hydroxyphenyl)propionate))(BASF), DOVERPHOS S-9228® Solid Phosphite Antioxidant (Dover Chemical), Irgafos® 168 (BASF) (Tris(2,4-di-tert.-butylphenyl)phosphite), and Irganox® (BASF) 1076, thioesters such as Dilauryl Thiodipropriate (DLTDP) and Distearyl Thiodiproprionate .

The step of infusing the cellulose ester composition with a five or six carbon branched alkane, such as isopentane, isohexane, or 2,3-dimethyl butane, is done so with an ultimate goal of achieving an approximate concentration in such pellets of this principal blowing agent of about 1 to about 12 weight percent, about 2 to about 8 weight percent, or about 3 to 7 weight percent. Other blowing agents may be utilized in conjunction with these principal blowing agents, provided such other blowing agents are utilized in no more than 75 weight percent of the total of all blowing agent utilized. Such other blowing agents include n-pentane, cyclohexane, cyclopentane, 2,2 dimethyl butane, 2,2,3 trimethyl butane, 2,2,3,3, tetramethyl butane, isoheptane, dimethyl pentane, and alcohols such as methanol, ethanol, and propanol, ketones such as acetone, methyl and ethyl esters such as methyl formate, methyl acetate, ethyl acetate, and the like.

In one embodiment, or in the alternative in combination with any other embodiment, the branched five carbon and six carbon alkanes is present at at least 20 weight percent, based on the total weight of the blowing agent. In one embodiment, or in the alternative in combination with any other embodiment, the branched five carbon and six carbon alkanes is present at from 20 weight percent to 50 weight percent, based on the total weight of the blowing agent. In one embodiment, or in the alternative in combination with any other embodiment, the branched five carbon and six carbon alkanes is present at from 20 weight percent to 35 weight percent, based on the total weight of the blowing agent. In one embodiment, or in the alternative in combination with any other embodiment, the branched five carbon and six carbon alkanes is present at from 20 weight percent to 55 weight percent, based on the total weight of the blowing agent. In one embodiment, or in the alternative in combination with any other embodiment, the branched five carbon and six carbon alkanes is present at from 20 weight percent to 65 weight percent, based on the total weight of the blowing agent.

The infusion step can be advantageously conducted in an extruder, with formation of pellets and ultimate quenching of said pellets or infused molten cellulose ester composition done under water, so as to entrain a suitable amount of blowing agent into the pellet, while at the same time controlling the temperature of said pellets so as to prevent premature expansion of said pellets into a blown foam. The infused pellets are thus useful as intermediates in the preparation of cellulose ester foams.

Accordingly, in a further aspect, the application discloses an infused pellet comprising a cellulose ester composition comprising:
(A) a cellulose ester having
(i) a DS of acetyl of about 0.0 to about 1.0;
(ii) a DS of butyryl of about 1.6 to about 3.0;
(iii) a DS of hydroxyl of about 0.0 to about 0.40; and
(iv) a Mn of about 2000 to about 95,000; and optionally
(B) a filler;
   wherein said pellet is infused with a blowing agent chosen from branched five and six carbon alkanes. (As used herein, the terms “pellet” and “bead” are used interchangeably and are intended to cover the same physical form.)

In certain embodiments, the DS of acetyl will range from about 0.1 to about 0.6; the DS of butyryl will range from about 2.2 to about 2.95; the DS of hydroxyl will range from about 0.01 to about 0.3; and the Mn will range from about 15,000 to 70,000.

The infused pellets are then treated thermally in order to afford molded articles comprised of such cellulose ester foam compositions. Such foams are useful as insulation boards, craft boards, packaging, helmet liners, etc. Advantageously, the density of such foams may range from about 10 to about 100 g/L. The foams thus formed were found to have a good combination of resistance to shrinkage as well as limited warpage upon formation, surprisingly even at lower density levels such as 10 to 50 g/L. Yet lower density levels of less than 30 g/L, of less than 25 g/L, or of less than 20 g/L can be achieved by treating the pellets to a double pre-expansion step as disclosed herein.

In this compounded cellulose ester composition, the composition may further comprise one or more flame retardants, nucleating agents, and odor masks.

As used herein, flame retardants can be classified as reactive or additive. Flame retardants can also be classified into several classes: minerals, organohalogen compounds, or organophosphorous compounds. Nonlimiting examples of minerals include aluminum hydroxide, magnesium hydroxide, huntite, hydromagnesite, red phosphorous, boron compounds, such as borates. Nonlimiting examples of organohalogen compounds include organochlorine compounds, such as chlorendic acid derivatives and chlorinated paraffins; organobromine compounds such as decabromodiphenyl ether, decabromodiphenyl ethane, polymeric brominated compounds such as brominated polystryenes, brominated carbonate oligomers, brominated epoxy oligomers, tetrabromophphthalic anhydride, tetrabromobisphenol A, and hexabromocyclododecane. Nonlimiting examples of organophosphorous compounds include organophosphates such as resorcinol bis(diphenylphosphate), bisphenol A diphenyl phosphate, and tricresyl phosphate; phosphonates such as dimethyl methyl phosphonate; phosphinates such as aluminum diethyl phosphinate; brominated organo phoshates such as tris(2,3dibromopropyl) phosphate, chlorinated organophosphates such as tris(1,3-dichloro-2-propyl) phosphate, and tetrakis(2-chloroethyl)dichloroisopentyldiphosphate. Thus, in a further embodiment, the invention provides the above compositions, further comprising one or more flame retardants.

In one embodiment, or in the alternative in combination with any other embodiment, the flame retardant is present from about 3 wt % to about 20 wt % based on the total weight of the composition. In one class of this embodiment, the flame retardant is an organophosphate compound.

In another aspect, the application discloses a cellulose ester foam pellet, comprising (A) a cellulose ester having (i) a DS of acetyl of about 0.0 to about 1.0; (ii) a DS of butyryl of about 1.6 to about 3.0; (iii) a DS of hydroxyl of about 0.0 to about 0.40; and (iv) a Mn of about 2000 to about 95,000; and optionally (B) a filler; wherein the foam pellet have a density of less than 25 g/L.

In one embodiment, or in the alternative, in combination with any other embodiment, the foam pellet further comprises a branched five and six carbon alkanes. The branched five and six carbon alkanes can be chosen from from isopentane, isohexane, and 2,3-dimethyl butane. In addition, the branched fix and six carbon alkanes is present in the foam pellet in the amount of from 0.1 weight percent to about 10 weight percent, based on the total weight of the foam pellet.

The cellulose esters of the invention generally comprise repeating units of the structure:

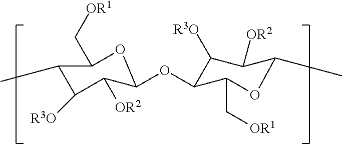

wherein R¹, R², and R³ may be chosen independently from hydrogen or a straight chain alkanoyl group chosen from acetyl and butyryl. For cellulose esters, the substitution level is usually expressed in terms of degree of substitution (“DS”), which is the average number of substituents per anhydroglucose unit (“AGU”).

Because DS is a statistical mean value, a value of 1 does not assure that every AGU has a single substituent. In some cases, there can be unsubstituted AGUs, some with two substituents, and some with three substituents. The “total DS” is defined as the average number of substituents per AGU.

In certain embodiments, the cellulose esters can have an inherent viscosity (“IV”) of at least about 0.4, 0.6, 0.8, or 1.0 deciliters/gram as measured at a temperature of 25° C. for a 0.25 gram sample in 100 ml of acetone. Additionally or alternatively, the cellulose esters can have an IV of not more than about 3.0, 2.5, 2.0, or 1.5 deciliters/gram as measured at a temperature of 25° C. for a 0.25 gram sample in 100 ml of acetone.

In certain embodiments, the cellulose esters can have a falling ball viscosity of at least about 0.5, 1, or 5 seconds. Additionally or alternatively, the cellulose esters can have a falling ball viscosity of not more than about 50, 45, 40, 35, 30, 25, 20, or 10 seconds.

In certain embodiments, the cellulose ester can have a glass transition temperature (“Tg”) of at least about 50° C., 55° C., 60° C., 65° C., 70° C., 75° C., or 80° C. Additionally or alternatively, the cellulose esters can have a Tg of not more than about 150° C.

The cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and from sources such as, for example, cotton linters, softwood pulp, hardwood pulp, corn fiber and other agricultural sources, and bacterial celluloses.

One method of producing cellulose esters is by esterification. In such a method, the cellulose is mixed with the appropriate organic acids, acid anhydrides, and catalysts and then converted to a cellulose triester. Ester hydrolysis is then performed by adding a water-acid mixture to the cellulose triester, which can be filtered to remove any gel particles or fibers. Water is added to the mixture to precipitate out the cellulose ester. The cellulose ester can be washed with water to remove reaction by-products followed by dewatering and drying.

### Cellulose Ester Compositions for Foamed Articles

The foams made from the cellulose ester compositions of the present application can be used to replace foams made from expandable polystyrene (“EPS”) for packaging, insulation, and other applications known in the art. EPS foams are made from polystyrene expandable particles. Therefore, the cellulose ester compositions of the present application can be formed into expandable particles or expandable cellulose ester particles (“ECEP”). The ECEP can be in the form of a bead, pellet or granule with average diameters in the range of from about 0.2 mm to about 10 mm, in the range of from about 0.2 to about 5 mm, in the range of from about 0.4 mm to about 8.5 mm, or in the range of from about 0.4 mm to about 7 mm. The ECEP can for example be spherical or elliptical.

In a further aspect, the compositions may further comprise a one or more plasticizers such as dioctyl adipate), (bis(2-ethylhexyl) adipate), triethylene glycol bis (2-ethylhexanoate) (TEG-EH), (Tris (2-Ethylhexyl) Trimellitate) (TOTM), polymeric plasticizers such as Admex 770, 760, 6995, 334F, 523, 6187, epoxidized oils such as epoxidized soybean oil and epoxidized linseed oil.

In a further aspect, the compositions described herein may be readily formulated as multi-part formulations that are mixed at and/or before the point of use, e.g., the individual parts of the multi-part formulation may be mixed at the point of manufacture of the cellulose ester foam. For example, a single shipping package may include at least two separate containers that may be mixed together by a user at the manufacturing facility and the mixed formulation may be delivered directly thereto. The shipping package and the internal containers or bladders of the package must be suitable for storing and shipping said composition components. Accordingly, in another aspect the application discloses a kit including, in one or more containers, one or more components adapted to form the compositions of the invention, wherein said components are chosen from:
(A) a cellulose ester having
(i) a DS of acetyl of about 0.0 to about 1.0;
(ii) a DS of butyryl of about 1.6 to about 3.0;
(iii) a DS of hydroxyl of about 0.0 to about 0.40; and
(iv) a Mn of about 2000 to about 95,000;
(B) a filler; and
(C) a blowing agent chosen from branched five and six carbon alkanes.

The cellulose ester foam, when used as insulating blocks or boards, possess improved dimensional stability, especially at lower densities. Accordingly, in a further aspect, the application discloses a cellulose ester foam as described herein, having a thickness of from about 0.5 cm to about 50 cm, or 5 cm to 30 cm, having a density of about 10 to about 50 g/L, while exhibiting less than about 10 percent, or less than about 6 percent shrinkage following blowing said foam into a mold. Additionally, when the articles are formed into such as car seat foam, helmets, furniture, etc., the density can be about 10-120 g/L.

Accordingly, in a further aspect, the application discloses a shaped or formed article comprising a cellulose ester foam, wherein said foam is comprised of
(A) a cellulose ester having
(i) a DS of acetyl of about 0.0 to about 1.0;
(ii) a DS of butyryl of about 1.6 to about 3.0;
(iii) a DS of hydroxyl of about 0.0 to about 0.40; and
(iv) a Mn of about 2000 to about 95,000; and optionally
(B) a filler;
   wherein said article is in the form of a board, ETICS, insulated concrete forms (ICF), exterior insulation and finish systems, playground floor surfacing, road construction, acoustic tiles, beverage coolers, surfboards, plant pots, insulated food containers, structural insulated panels (SIPs), helmet liner, car seat foam, seating components, protective packaging, packing peanuts, furniture stuffing, craft foam boards, automotive components, heating and air components, boating components, underfloor.

### Additional Embodiments

Embodiment 1. A process for preparing a cellulose ester foam, which comprises
(I) compounding a cellulose ester composition comprising:
   (A) a cellulose ester having
      (i) a DS of acetyl of about 0.0 to about 1.0;
      (ii) a DS of butyryl of about 1.6 to about 3.0;
      (iii) a DS of hydroxyl of about 0.0 to about 0.40; and
      (iv) a Mn of about 2000 to about 95,000; and optionally
   (B) a filler;
and forming pellets; followed by
(II) infusing said pellets with at a blowing agent chosen from branched five carbon and six carbon alkanes to form infused pellets; followed by
(Ill) thermally expanding said infused pellets to form a foam.

Embodiment 2. The process of embodiment 1, wherein the DS of acetyl is from about 0.1 to about 0.6.

Embodiment 3. The process of any one of embodiments 1-2, wherein the DS of butyryl is from about 2.2 to about 2.95.

Embodiment 4. The process of any one of embodiments 1-3, wherein the composition further comprises a stabilizer.

Embodiment 5. The process of any one of embodiments 1-4, wherein the composition further comprises an odor mask.

Embodiment 6. The process of any one of embodiment 1-5, wherein the blowing agent is present in an amount of about 2 weight percent to about 12 weight percent, based on the total weight of the composition.

Embodiment 7. The process of any one of embodiment 1-6, wherein the branched five carbon and six carbon alkanes are chosen from isopentane, isohexane, and 2,3-dimethyl butane.

Embodiment 8. The process of embodiments 1-7, wherein the branched five carbon and six carbon alkanes is present at at least 20 weight percent, based on the total weight of the blowing agent.

Embodiment 9. The process of any one of embodiments 1-8, wherein the blowing agent further comprises one or more of n-pentane, C₁-C₆ alkanols, C₃-C₆ ketones, and C₂-C₈ alkyl esters.

Embodiment 10. An infused pellet comprising a cellulose ester composition comprising:
(A) a cellulose ester having
(i) a DS of acetyl of about 0.0 to about 1.0;
(ii) a DS of butyryl of about 1.6 to about 3.0;
(iii) a DS of hydroxyl of about 0.0 to about 0.40; and
(iv) a Mn of about 2000 to about 95,000; and optionally
(B) a filler;
   wherein said pellet is infused with a blowing agent chosen from branched five and six carbon alkanes.

Embodiment 11. The pellet of embodiment 10, wherein the blowing agent is present in an amount of about 2 weight percent to about 12 weight percent, based on the total weight of the composition.

Embodiment 12. The pellet of any one of embodiments 10-11, wherein the branched five and six carbon alkane is chosen from isopentane, isohexane, and 2,3-dimethyl butane.

Embodiment 13. The pellet of any one of embodiments 10-12, wherein the branched five carbon and six carbon alkanes is present at least 20 weight percent, based on the total weight of the blowing agent.

Embodiment 14. The pellet of any one of embodiment 10-13, wherein the blowing agent further comprises one or more of n-pentane, C₁-C₆ alkanols, C₃-C₆ ketones, and C₂-C₈ alkyl esters.

Embodiment 15. The pellet of any one of embodiments 10-14, wherein the DS of acetyl ranges from about 0.1 to about 0.6; the DS of butyryl ranges from about 2.2 to about 2.95; the DS of hydroxyl ranges from about 0.01 to about 0.3; and the Mn ranges from about 15,000 to 70,000.

Embodiment 16. A shaped or formed article comprising a cellulose ester foam, wherein said foam is comprised of
(A) a cellulose ester having
(i) a DS of acetyl of about 0.0 to about 1.0;
(ii) a DS of butyryl of about 1.6 to about 3.0;
(iii) a DS of hydroxyl of about 0.0 to about 0.40; and
(iv) a Mn of about 2000 to about 95,000; and optionally
(B) a filler;
   wherein said article is in the form of a board, ETICS, insulated concrete forms (ICF), exterior insulation and finish systems, playground floor surfacing, road construction, acoustic tiles, beverage coolers, surfboards, plant pots, insulated food containers, structural insulated panels (SIPs), helmet liner, car seat foam, seating components, protective packaging, packing peanuts, furniture stuffing, craft foam boards, automotive components, heating and air components, boating components, underfloor insulation, and roof liners,

Embodiment 17. The article of embodiment 16, wherein the DS of acetyl ranges from about 0.1 to about 0.6; the DS of butyryl ranges from about 2.2 to about 2.95; the DS of hydroxyl ranges from about 0.01 to about 0.3; and the Mn ranges from about 15,000 to 70,000.

Embodiment 18. The article of any one of embodiments 16 or 17, having a density of about 10 to about 40 g/L.

Embodiment 19. The article of any one of embodiments 16-18, wherein the shrinkage of the article relative to its mold is less than about 6%.

Embodiment 20. The article of embodiment 19, wherein the differential shrinkage of the article relative to its mold is less than about 5%.

### Definitions

In this application, reference will be made to a number of terms, which shall be defined to have the following meanings:

“Infused” means to inject, attach, introduce, or otherwise include material or blowing agent into the cellulose ester composition.

“Blowing agent” means all blowing agents known to one of ordinary skill in the art. Non-limiting examples include alkanes or haloalkanes such as propane, n-butane, isobutene, n-pentane, isopentane, neopentane, cyclopentane, and or hexane and its isomers, alcohols, ketones, esters, ethers, 1,1,1,3,3-pentafluloropentane, 1,1,1,4,4,4-hexafluoro-2-butene, or mixtures thereof. In the practice of the present invention, the primary blowing agent is comprised of branched C6 species such as isohexane or 2,3-dimethyl butane.

Values may be expressed as “about” or “approximately” a given number. Similarly, ranges may be expressed herein as from “about” one particular value and/or to “about” or another particular value. When such a range is expressed, another aspect includes from the one particular value and/or to the other particular value. Similarly, when values are expressed as approximations, by use of the antecedent “about,” it will be understood that the particular value forms another aspect.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the term “chosen from” is used with a list of two or more items, and has a specific meaning when used in conjunction with either “and” or “or.” For example, if a composition is described as chosen from A, B and C, the composition can contain A alone, B alone or C alone. If a composition is described as chosen from A, B, or C, the composition can contain A alone, B, alone, C alone, the combination of A and B, the combination of A and C, or the combination of A, B and C.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

This invention can be further illustrated by the following examples of certain embodiments thereof, although it will be understood that these examples are included merely for purposes of illustration and are not intended to limit the scope of the invention unless otherwise specifically indicated.

### Abbreviations

BA is blowing agent; h or hr is hour(s); sec is second(s);

### EXAMPLES

In the examples below, the foamed cellulose acetate butyrate was molded to have a part shrinkage relative to the mold dimensions of less than 10% or less than 6%. In addition to the overall part shrinkage, warpage is a of concern to ultimate application utility. As a measure of warpage, differential shrinkage relative to the mold, on “Face A” and an opposing “Face B” was measured. Differential shrinkage between Face A and Face B is advantageously less than 10% or less than 5% to minimize undesired part warpage.

(See, for example Table 9 below.)

### Molecular Weight Determination by GPC

M_{w} and Mₙ were measured using THF to determine the absolute M_{w} and Mₙ of the CE. The instrumentation for the THF/cellulose ester procedure consists of the following Agilent 1200 series components: degasser, isocratic pump, auto-sampler, column oven, UV/Vis detector and a refractive index detector). The following method is used to calculate the absolute molecular weight values for CE. The solvent is THF stabilized with BHT Preservative. The test temperature is 30° C. and flow rate is 1.0 ml/min. A sample solution of 25 mg Cellulose Ester in 10 ml THF with BHT preservative +10 μl toluene flow rate marker as made. The injection volume is 50 μl. The column set is Polymer Laboratories 5 μm PLgel, Guard+Mixed C+Oligopore. The detection is by refractive index. The calibrants are monodisperse polystyrene standards, M_{w}=580 to 3,220,000 from Polymer Laboratories. The universal calibration parameters are as follows: PS (K=0.0001280 and a=0.7120) and CA (K=0.00007572 and a=0.8424). The universal calibration parameters above were determined by light scattering and viscometery to yield the correct weight average or number average molecular weights.

### Formulation

Samples were formulated to include a polymer, stabilizer, filler, and odor mask. The cellulose ester was CAB 500-5, available from Eastman Chemical Company, which is a cellulose acetate butyrate. The stabilizer was Vikoflex® 7170 epoxidized soybean oil, available from Arkema. The filler was either Natural Graphite MGF499.5X (Graphit Kropfmühl GmbH /Qingdao Kropfmuehl Graphite Co.) for making a grey formulation or Mistron ZSC talc, available from Imerys Performance Additives, for making a white formulation. The odor mask used in these formulations was Vanillin U.S.P. Materials were compounded on a Leistritz 18 mm twin screw extruder having a 50:1 L/D at 180 to 200° C. and 400 to 500 rpms using a medium shear screw configuration at a rate of 15 to 20 lbs/hour.

TABLE 1
Formulation Details.

| | Sample # | | | | | |
|---|---|---|---|---|---|---|
| | 25-1 | 25-2 | 25-3 | 25-4 | 25-5 | 25-6 |
| CAB 500-5 | 93.8 | 93.8 | 93.8 | 93.8 | 93.8 | 93.5 |
| (wt %) | | | | | | |
| Filler | MGF499.5X | MGF499.5X | MGF499.5X | MGF499.5X | Mistron ZSC | MG499.5X |
| (wt %) | (4) | (4) | (4) | (4) | (4) | (4) |
| Vikoflex | 2 | 2 | 2 | 2 | 2 | 2 |
| 7170 | | | | | | |
| (wt %) | | | | | | |
| Vanillin | 0.20 | 0.20 | 0.20 | 0.20 | 0.20 | 0.5 |
| USP | | | | | | |
| (wt %) | | | | | | |

### Making the Beads

Compounded materials were then processed on a ZSK 26 extruder, having a Extrex 36-5 gear pump and a MAP 5 Pelletizer. The blowing agent was metered into the extruder about ⅔the way down the barrel using a JASCO PU-2087 Plus metering pump. For all samples, a target of 6% blowing agents was targeted in the polymer formulation. The Isopentane CAS registry number is 78-78-4. Isohexane can be higher purity as listed in CAS registry number (107-83-5) or a product with some hydrocarbon impurities and sold under CAS registry number 64742-49-0.

Bead formulation details including blowing agent type and ratios can be seen in Table 2 below. Bead processing conditions for processing rate, processing temperature, processing speeds, can be observed in Table 3.

TABLE 2
Bead Formulation

Blowing Agent

| | | Isopentane | Isohexane |
|---|---|---|---|
| Material # | CE Formulation | (wt %) | (wt %) |
| 25-1 | Grey CE | 6 | 0 |
| 25-2 | Grey CE | 4.5 | 1.5 |
| 25-3 | Grey CE | 3 | 3 |
| 25-4 | Grey CE | 0 | 6 |
| 25-5 | White CE | 3 | 3 |
| 25-6 | Grey CE | 4.8 | 1.2 |

TABLE 3
Bead Formulation Processing Conditions

| | Material # | | | | | |
|---|---|---|---|---|---|---|
| | 25-1 | 25-2 | 25-3 | 25-4 | 25-5 | 25-6 |
| Zone 1, ° C. | na | na | na | na | na | Na |
| Zone 2, ° C. | 120 | 120 | 120 | 120 | 120 | 120 |
| Zone 3, ° C. | 165 | 165 | 170 | 170 | 170 | 170 |
| Zone 4, ° C. | 180 | 185 | 185 | 180 | 180 | 180 |
| Zone 5, ° C. | 180 | 185 | 185 | 180 | 180 | 180 |
| Zone 6, ° C. | 180 | 180 | 185 | 180 | 180 | 180 |
| Zone 7, ° C. | 180 | 180 | 170 | 175 | 175 | 175 |
| Zone 8, ° C. | 180 | 180 | 170 | 162 | 170 | 170 |
| Zone 9, ° C. | 180 | 180 | 170 | 162 | 170 | 165 |
| Zone 10, ° C. | 170 | 170 | 165 | 160 | 165 | 165 |
| screw speed, rpm | 230 | 230 | 220 | 270 | 270 | 270 |
| torque, % | 31 | 34 | 32 | 40 | 43 | 40 |
| Melt Pressure, bar | 34 | 32 | 30 | 34 | 33 | — |
| Melt Temp., ° C. | 262 | 163 | 158 | 160 | 163 | 160 |
| Inlet Adapter, ° C. | — | — | — | — | — | 165 |
| Gear Pump, ° C. | 170 | 170 | 170 | 170 | 165 | 165 |
| Exit Adapter, ° C. | — | — | — | — | — | 165 |
| Divertor, ° C. | 224 | 212 | 206 | 207 | 200 | 210 |
| Die, Plate, ° C. | 315 | 285 | 285 | 285 | 280 | 285 |
| Back Pressure, bar | 6.5 | 8 | 6 | 6 | 5 | 6.5 |
| Water Temp., ° C. | 34 | 30 | 35 | 35 | 35 | 32 |
| Cutter Knife Speed, rpm | 5000 | 5000 | 5000 | 4900 | 5000 | 5000 |
| Output Rate, kg/h | 16 | 15 | 15 | 24 | 24 | 24 |
| Pump, ml/min. | 28 | 27.5 | 27 | 42.5 | 41.5 | |

### Pre-expansion and Molding

The materials were pre-expanded and molded using an EMbead ED2-HP pre-exander and EHVC-E 870/670 molding machine. The prexpansion density and process conditions are listed in Table 4. The density was determined by weighing the material that filled a 1 liter volume. Beads subjected to a single pre-expansion had a density of from 27.6 to 31.4 g/I.

Table 5 provides the reduced density achievable when the beads are treated to pre-expansion conditions two times using Material #25-6. The results show that for equilibration times of 5 to 6 hours, beads had a density of 19 to 20 g/l. When the equilibration is extended to 22 to 23 hrs, a density of 19 to 21 g/l is still achievable. Likewise, the results show that that after an equilibration time of 22 to 23 hrs, a density of 19 to 21 g/l can be achieved illustrating product robustness of density to equilibration and storage time.

TABLE 4
Prexpansion Conditions and Bead Density

| | Steam | Steam | Bead |
|---|---|---|---|
| | Temp. | Time | Density |
| Material # | ° C. | (seconds) | g/L |
| 25-1 | 97 | 30 | 30.3 |
| 25-2 | 100 | 30 | 29.4 |
| 25-3 | 100 | 30 | 28.6 |
| 25-4 | 102 | 40 | 31.4 |
| 25-5 | 102 | 20 | 27.6 |
| 25-6 | 97 | 25 | 28.0 |

TABLE 5
Double Expansion Conditions and Bead Density

| | | Steam | Steam | Bead |
|---|---|---|---|---|
| | Equilibration | Pressure | Time | Density |
| Material # | Time (h) | (bar) | (Sec) | (g/l) |
| 25-6 | 5.25 | 0.1 | 40 | 32.5 |
| 25-6 | 5.42 | 0.08 | 20 | 22.1 |
| 25-6 | 5.58 | 0.07 | 20 | 20.9 |
| 25-6 | 5.83 | 0.05 | 20 | 19.8 |
| 25-6 | 6 | 0.03 | 30 | 20.5 |
| 25-6 | 22.5 | 0.1 | 40 | 45 |
| 25-6 | 22.75 | 0.08 | 20 | 22.6 |
| 25-6 | 23 | 0.07 | 20 | 20.4 |
| 25-6 | 23.16 | 0.05 | 20 | 19.4 |
| 25-6 | 23.33 | 0.03 | 30 | 21.3 |

The molding conditions are listed in Table 6 for making boards from select single pre-expansed beads. The parts are heated with steam through the thickness using cross steam and the faces are heated with autoclave steam, the parts are cooled by spraying water on the surface as well pulling vacuum.

TABLE 6
Molding Conditions using beads subjected
to a single pre-expansion.

| | | | Crossteam | Autoclave | Cooling |
|---|---|---|---|---|---|
| | | | Pressure | Pressure | Spray |
| | | | (bar) | (bar) | (sec) |
| | | Molding | [Time | [Time | [vacuum |
| Material # | Board # | Delay | (sec)] | (sec)] | (sec)] |
| 25-1 | 4 | 0 | 0.25 [7] | 0.9 [6] | 15 [40] |
| 25-1 | 5 | 0 | 0.25 [7] | 0.9 [6] | 15 [40] |
| 25-1 | 4A | 2 | 0.25 [7] | 0.9 [6] | 15 [40] |
| 25-1 | 5A | 2 | 0.25 [7] | 0.9 [6] | 15 [40] |
| 25-1 | 2B | 16 | 0.25 [7] | 0.9 [6] | 15 [40] |
| 25-1 | 4B | 16 | 0.25 [7] | 0.9 [6] | 15 [40] |
| 25-2 | 4 | 0 | 0.3 [7] | 0.9 [6] | 15 [50] |
| 25-2 | 6 | 0 | 0.3 [7] | 1 [6] | 15 [50] |
| 25-2 | 4A | 2 | 0.3 [7] | 1 [6] | 15 [50] |
| 25-2 | 5A | 2 | 0.3 [7] | 1 [6] | 15 [50] |
| 25-2 | 4B | 16 | 0.3 [7] | 1 [6] | 15 [50] |
| 25-2 | 5B | 16 | 0.3 [7] | 1 [6] | 15 [50] |
| 25-3 | 7 | 0 | 0.25 [7] | 0.85 [6] | 15 [50] |
| 25-3 | 8 | 0 | 0.3 [7] | 0.9 [6] | 15 [50] |
| 25-3 | 4A | 2 | 0.3 [7] | 0.9 [6] | 15 [50] |
| 25-3 | 5A | 2 | 0.3 [7] | 0.9 [6] | 15 [50] |
| 25-3 | 5B | 16 | 0.25 [7] | 0.85 [7] | 15 [50] |
| 25-3 | 6B | 16 | 0.25 [7] | 0.85 [7] | 15 [50] |
| 25-4 | 2 | 0 | 0.3 [7] | 0.9 [6] | 15 [50] |
| 25-4 | 3 | 0 | 0.3 [7] | 0.9 [6] | 15 [50] |
| 25-4 | 2A | 2 | 0.3 [7] | 0.9 [6] | 15 [50] |
| 25-4 | 3A | 2 | 0.3 [7] | 0.9 [6] | 15 [50] |
| 25-4 | 6B | 16 | 0.3 [7] | 0.9 [6] | 15 [50] |
| 25-4 | 7B | 16 | 0.3 [7] | 0.9 [6] | 15 [50] |
| 25-5 | 4 | 0 | 0.25 [7] | 0.85 [6] | 15 [50] |
| 25-5 | 5 | 0 | 0.3 [7] | 0.9 [6] | 15 [50] |
| 25-5 | 3B | 16 | 0.3 [7] | 0.9 [6] | 15 [50] |
| 25-5 | 4B | 16 | 0.3 [7] | 0.9 [6] | 15 [50] |

From Table 7 below, it can be observed that part shinkage decreases substantially as a function of C6 hydrocarbon loading, while achieving equal to or better than part density. Part density was determined by the standard density equaltion of ρ=m/V. Part shrinkage was calcuated based on area of Face A as illustrated in drawing 1 below. Since these parts did not exhibit warping, calcuating shrinkage using one face was adequate. Shrinkage can be calcualted by usin the following equation (part dimensions-mold dimensions)/(mold dimensions). The mold dimesions were 810 mm by 610 mm by 50 mm. A negative value indicates a part less than the size of the mold while a positive value indicates no shrinkage occured. Additionally, the beads were expanded and then equilibrated for various times to understand the impact of molding delay on part dimensional stability. As the data shows, isopentane alone has negative shrinkage while the incorporation of isohexane as the one of the blowing agents allows for the production of parts with minimal to no shrinkage. Also one should note that lower density can be achieved with mixed blowing agents.

TABLE 7
Part Dimensions, Shrinkage, Mass and Density

| | | Molding | L | W | T | Shrinkage | Weight | Density |
|---|---|---|---|---|---|---|---|---|
| Material # | Board # | Delay (h) | (mm) | (mm) | (mm) | % | (Kg) | (g/L) |
| 25-1 | 4 | 0 | 785 | 595 | 48 | −5.47% | 0.898 | 40.05 |
| 25-1 | 5 | 0 | 802 | 603 | 48 | −2.12% | 0.900 | 38.77 |
| 25-1 | 4A | 2 | 795 | 600 | 48 | −3.46% | 0.854 | 37.30 |
| 25-1 | 5A | 2 | 795 | 600 | 47 | −3.46% | 0.848 | 37.83 |
| 25-1 | 2B | 16 | 785 | 585 | 47 | −7.06% | 0.850 | 39.38 |
| 25-1 | 4B | 16 | 795 | 600 | 47 | −3.46% | 0.867 | 38.67 |
| 25-2 | 4 | 0 | 820 | 620 | 50 | 2.89% | 0.898 | 35.33 |
| 25-2 | 6 | 0 | 823 | 620 | 50 | 3.27% | 0.869 | 34.06 |
| 25-2 | 4A | 2 | 820 | 620 | 50 | 2.89% | 0.787 | 30.96 |
| 25-2 | 5A | 2 | 820 | 620 | 50 | 2.89% | 0.78 | 30.68 |
| 25-2 | 4B | 16 | 815 | 614 | 50 | 1.28% | 0.781 | 31.21 |
| 25-2 | 5B | 16 | 815 | 614 | 50 | 1.28% | 0.772 | 30.85 |
| 25-3 | 7 | 0 | 815 | 615 | 50 | 1.44% | 0.819 | 32.68 |
| 25-3 | 8 | 0 | 820 | 615 | 50 | 2.06% | 0.83 | 32.92 |
| 25-3 | 4A | 2 | 820 | 615 | 50 | 2.06% | 0.81 | 32.12 |
| 25-3 | 5A | 2 | 820 | 620 | 50 | 2.89% | 0.8 | 31.47 |
| 25-3 | 5B | 16 | 816 | 613 | 50 | 1.24% | 0.792 | 31.67 |
| 25-3 | 6B | 16 | 815 | 615 | 50 | 1.44% | 0.793 | 31.64 |
| 25-4 | 2 | 0 | 818 | 615 | 49 | 1.82% | 1 | 40.57 |
| 25-4 | 3 | 0 | 820 | 615 | 49 | 2.06% | 0.958 | 38.77 |
| 25-4 | 2A | 2 | 825 | 620 | 50 | 3.52% | 0.92 | 35.97 |
| 25-4 | 3A | 2 | 815 | 615 | 50 | 1.44% | 0.915 | 36.51 |
| 25-4 | 6B | 16 | 815 | 615 | 50 | 1.44% | 0.888 | 35.43 |
| 25-4 | 7B | 16 | 815 | 615 | 50 | 1.44% | 0.892 | 35.59 |
| 25-5 | 4 | 0 | 815 | 615 | 50 | 1.44% | 0.798 | 31.84 |
| 25-5 | 5 | 0 | 819 | 615 | 50 | 1.94% | 0.812 | 32.24 |
| 25-5 | 3B | 16 | 815 | 613 | 50 | 1.11% | 0.756 | 30.26 |
| 25-5 | 7B | 16 | 816 | 614 | 50 | 1.40% | 0.76 | 30.34 |

In addition to making parts of dimensions of 810 mm by 610 mm by 50 mm. Thicker parts were made to understand part shrinkage as a function of thickness. The new part was 810 mm by 610 mm by 150 mm. To have a robust product, the part needs to be molded without shrinkage and warpage as the part thickness increases. We have discovered that using a C6 blowing agent alone or in combination with C5 or C4 blowing agents results in parts with good density and good dimensional stability with low warpage. For preparation for molding the thicker parts, the materials were pre-expanded EMbead ED2-HP pre-exander. The prexpansion density and process conditions are listed in Table 8. The density was determined by weighing the material that filled a 1 liter volume.

TABLE 8
Pre-expansion process conditions and expanded
bead density for making 150 mm boards

| | Steam | Steam | Bead |
|---|---|---|---|
| Material | Temp. | Time | Density |
| # | (° C.) | (sec) | (g/L) |
| 25-1 | 97 | 30 | 28.8 |
| 25-2 | 100 | 25 | 29.8 |
| 25-3 | 100 | 25 | 28.5 |
| 25-4 | 100 | 25 | 32.5 |
| 25-7 | 102 | 20 | 28.2 |

TABLE 9
Process conditions for 150 mm thick boards.

| | | | Crossteam | | Autoclave | | Cooling | |
|---|---|---|---|---|---|---|---|---|
| | | Molding | Pressure | Time | Pressure | Time | Spray | Vacuum |
| Material # | Board # | Delay (hrs) | (bar) | (sec) | (bar) | (sec) | (sec) | (Sec) |
| 25-1 | T10 | 4 | 0.35 | 7 | 1 | 6 | 15 | 140 |
| 25-1 | T11 | 4 | 0.35 | 7 | 1 | 6 | 15 | 160 |
| 25-2 | T7 | 4 | 0.3 | 7 | 0.9 | 7 | 15 | 175 |
| 25-2 | T8 | 4 | 0.3 | 7 | 0.9 | 7 | 15 | 175 |
| 25-3 | T10 | 4 | 0.3 | 6 | 1 | 6 | 15 | 150 |
| 25-3 | T11 | 4 | 0.3 | 6 | 1.02 | 6 | 15 | 150 |
| 25-4 | T3 | 4 | 0.3 | 6 | 1 | 6 | 15 | 150 |
| 25-4 | T4 | 4 | 0.3 | 6 | 1 | 6 | 15 | 150 |
| 25-7 | T10 | 4 | 0.3 | 6 | 1 | 6 | 15 | 170 |
| 25-7 | T11 | 4 | 0.3 | 6 | 1 | 6 | 15 | 170 |

TABLE 10
Molded part dimensions, shrinkage and warpage for 150 mm boards.

| | | Face A | Face A | Area % | Face B | Face B | Area % | |
|---|---|---|---|---|---|---|---|---|
| Material # | Board # | Length (mm) | Width (mm) | Change | Length (mm) | Width (mm) | Change | Warped |
| 25-1 | T10 | 808 | 606 | −0.90% | 765 | 568 | −12.06% | yes |
| 25-1 | T11 | 813 | 611 | 0.53% | 770 | 578 | −9.93% | yes |
| 25-2 | T7 | 810 | 614 | 0.66% | 800 | 603 | −2.37% | no |
| 25-2 | T8 | 815 | 614 | 1.28% | 799 | 601 | −2.81% | no |
| 25-3 | T10 | 809 | 610 | −0.12% | 803 | 606 | −1.51% | no |
| 25-3 | T11 | 807 | 607 | −0.86% | 805 | 605 | −1.43% | no |
| 25-4 | T3 | 814 | 613 | 0.99% | 809 | 610 | −0.12% | no |
| 25-4 | T4 | 810 | 608 | −0.33% | 805 | 606 | −1.27% | no |
| 25-7 | T10 | 805 | 602 | −1.92% | 800 | 601 | −2.69% | no |
| 25-7 | T11 | 810 | 610 | 0.00% | 799 | 602 | −2.65% | no |

Face A is listed as the top of the curved sample
Face B is listed as the bottom of the curved sample

The invention has been described in detail with particular reference to certain embodiments thereof, but it will be understood that variations and modifications can be effected within the spirit and scope of the invention.

1. A process for preparing a cellulose ester foam, which comprises
(I) compounding a cellulose ester composition comprising:
(A) a cellulose ester having
(i) a DS of acetyl of about 0.0 to about 1.0;
(ii) a DS of butyryl of about 1.6 to about 3.0;
(iii) a DS of hydroxyl of about 0.0 to about 0.40; and
(iv) a Mn of about 2000 to about 95,000; and optionally
(B) a filler;
and forming pellets; followed by
(II) infusing said pellets with at a blowing agent chosen from branched five carbon and six carbon alkanes to form infused pellets; followed by
(III) thermally expanding said infused pellets to form a foam.

2. The process of claim 1, wherein the DS of acetyl is from about 0.1 to about 0.6.

3. The process of claim 2, wherein the DS of butyryl is from about 2.2 to about 2.95.

4. The process of claim 1, wherein the composition further comprises a stabilizer.

5. The process of claim 1, wherein the composition further comprises an odor mask.

6. The process of claim 1, wherein the blowing agent is present in an amount of about 2 weight percent to about 12 weight percent, based on the total weight of the composition.

7. The process of claim 1, wherein the branched five carbon and six carbon alkanes are chosen from isopentane, isohexane, and 2,3-dimethyl butane.

8. The process of claim 7, wherein the branched five carbon and six carbon alkanes is present at at least 20 weight percent, based on the total weight of the blowing agent.

9. The process of claim 1, wherein the blowing agent further comprises one or more of n-pentane, C₁-C₆ alkanols, C₃-C₆ ketones, and C₂-C₈ alkyl esters.

10. An infused pellet comprising a cellulose ester composition comprising:
(A) a cellulose ester having
(i) a DS of acetyl of about 0.0 to about 1.0;
(ii) a DS of butyryl of about 1.6 to about 3.0;
(iii) a DS of hydroxyl of about 0.0 to about 0.40; and
(iv) a Mn of about 2000 to about 95,000; and optionally
(B) a filler;
wherein said pellet is infused with a blowing agent chosen from branched five and six carbon alkanes.

11. The pellet of claim 10, wherein the blowing agent is present in an amount of about 2 weight percent to about 12 weight percent, based on the total weight of the composition.

12. The pellet of claim 10, wherein the branched five and six carbon alkanes is chosen from isopentane, isohexane, and 2,3-dimethyl butane.

13. The pellet of claim 12, wherein the branched five carbon and six carbon alkanes is present at at least 20 weight percent, based on the total weight of the blowing agent.

14. The pellet of claim 10, wherein the blowing agent further comprises one or more of n-pentane, C₁-C₆ alkanols, C₃-C₆ ketones, and C₂-C₈ alkyl esters.

15. The pellet of claim 10, wherein the DS of acetyl ranges from about 0.1 to about 0.6; the DS of butyryl ranges from about 2.2 to about 2.95; the DS of hydroxyl ranges from about 0.01 to about 0.3; and the Mn ranges from about 15,000 to 70,000.

16. A shaped or formed article comprising a cellulose ester foam, wherein said foam is comprised of
(A) a cellulose ester having
(i) a DS of acetyl of about 0.0 to about 1.0;
(ii) a DS of butyryl of about 1.6 to about 3.0;
(iii) a DS of hydroxyl of about 0.0 to about 0.40; and
(iv) a Mn of about 2000 to about 95,000; and optionally
(B) a filler;
wherein said article is in the form of a board, ETICS, insulated concrete forms (ICF), exterior insulation and finish systems, playground floor surfacing, road construction, acoustic tiles, beverage coolers, surfboards, plant pots, insulated food containers, structural insulated panels (SIPs), helmet liner, car seat foam, seating components, protective packaging, packing peanuts, furniture stuffing, craft foam boards, automotive components, heating and air components, boating components, underfloor insulation, and roof liners,

17. The article of claim 16, wherein the DS of acetyl ranges from about 0.1 to about 0.6; the DS of butyryl ranges from about 2.2 to about 2.95; the DS of hydroxyl ranges from about 0.01 to about 0.3; and the Mn ranges from about 15,000 to 70,000.

18. The article of any one of claim 17, having a density of about 10 to about 40 g/L.

19. The article of claim 18, wherein the shrinkage of the article relative to its mold is less than about 6%.

20. The article of claim 18, wherein the differential shrinkage of the article relative to its mold is less than about 5%.
